(19) United States
(12) Patent Application Publication
(10) Pub. No.: US 2019/0197456 A1
(43) Pub. Date: Jun. 27, 2019

(54) SYSTEMS AND METHODS FOR PROVIDING AN ATTRIBUTED REVIEW FRAMEWORK ASSOCIATED WITH A SOCIAL NETWORKING SYSTEM

(71) Applicant: Facebook, Inc., Menlo Park, CA (US)

(72) Inventor: Subramoniam Perumal, Mountain View, CA (US)

(21) Appl. No.: 15/851,466

(22) Filed: Dec. 21, 2017

(51) Int. Cl. G06Q 10/06; G06F 17/30; G06Q 50/00

(52) U.S. Cl. CPC G06Q 10/06398; G06Q 50/01; G06F 17/30864

(57) ABSTRACT

Systems, methods, and non-transitory computer readable media can obtain information associated with a review relating to an entity. One or more names of a plurality of persons associated with the entity can be provided, the one or more names matching at least a portion of the information associated with the review. In response to selection of a person based on the one or more names, a link to a profile of the selected person can be generated. An attributed review of the person including the link can be generated.

### FIELD OF THE INVENTION

The present technology relates to the field of social networks. More particularly, the present technology relates to techniques for providing reviews associated with entities within social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access. As a further example, a content item can be presented through a page associated with an entity. For instance, the content item can be a review associated with the entity.

### SUMMARY

Various embodiments of the present disclosure can include systems, methods, and non-transitory computer readable media configured to obtain information associated with a review relating to an entity. One or more names of a plurality of persons associated with the entity can be provided, the one or more names matching at least a portion of the information associated with the review. In response to selection of a person based on the one or more names, a link to a profile of the selected person can be generated. An attributed review of the person including the link can be generated.

In some embodiments, the profile includes one or more of: a name of the selected person, a profile photo of the selected person, a cover photo associated with the selected person, or a role of the selected person in connection with the entity.

In certain embodiments, the entity is an employer, the plurality of persons is a plurality of employees, and the selected person is a selected employee.

In an embodiment, the employer has enabled an opt in for allowing a user creating a review relating to the employer to attribute the review to at least one of the plurality of employees associated with the employer.

In some embodiments, the selected employee has enabled an opt in for attributing a review relating to the employer to the selected employee.

In certain embodiments, the providing one or more names of a plurality of persons includes providing roles of the plurality of employees in connection with the employer and profile photos of the plurality of employees.

In an embodiment, the employer is represented as a page within a social networking system, and the attributed review is published on the page.

In some embodiments, the attributed review is shared with one or more users including a connection of the selected employee.

In certain embodiments, attributed reviews relating to the selected employee can be aggregated, wherein the attributed reviews relate to a plurality of employers including the employer.

In an embodiment, the selected employee is associated with a plurality of employers, and a respective profile is created for each employer of the plurality of employers.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example review attribution framework module configured to provide attributed reviews associated with entities, according to an embodiment of the present disclosure.

FIG. 2A illustrates an example employer module configured to allow employer management of attributed reviews, according to an embodiment of the present disclosure.

FIG. 2B illustrates an example employee module configured to allow employee management of attributed reviews, according to an embodiment of the present disclosure.

FIG. 2C illustrates an example attributed review generation module configured to generate attributed reviews, according to an embodiment of the present disclosure.

FIG. 3A illustrates an example scenario for providing attributed reviews associated with entities, according to an embodiment of the present disclosure.

FIG. 3B illustrates an example scenario for providing attributed reviews associated with entities, according to an embodiment of the present disclosure.

FIG. 4 illustrates an example first method for providing attributed reviews associated with entities, according to an embodiment of the present disclosure.

FIG. 5 illustrates an example second method for providing attributed reviews associated with entities, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Providing an Attributed Review Framework Associated with a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access. As a further example, a content item can be presented through a page associated with an entity. For instance, the content item can be a review associated with the entity.

Conventional approaches specifically arising in the realm of computer technology can provide reviews of people associated with entities. The reviews can be created by users. For example, entities may be represented as pages within a social networking system. A user can write a review associated with an entity, and the review can be published on a page associated with the entity. In some cases, the review can relate to a specific employee or other affiliated person related to the entity. However, a reference to the specific employee in the review may not include sufficient details to identify the specific employee. Accordingly, it can be difficult to determine to which employee the review relates.

An improved approach rooted in computer technology can overcome the foregoing and other disadvantages associated with conventional approaches specifically arising in the realm of computer technology. Based on computer technology, the disclosed technology can support creation and management of reviews that can be attributed to specific people associated with an entity. In some instances, reviews can be provided on a page associated with the entity. For example, an entity can be an employer, and people associated with the entity can include employees, independent contractors, or any other people affiliated with the entity. An employer can opt in to permit attribution of reviews to employees. The employer can add or remove employees. An employee can also opt in to permit attribution of reviews to the employee. An employee can create a profile of the employee for the particular employer and customize information included in the profile. An employee can choose to share reviews relating to the employee with other users, such as connections of the employee. For example, reviews relating to the employee can be provided in a feed of another user. A user creating a review for an employer can attribute the review to a specific employee of the employer. For example, when the user creates a review and enters a name of an employee, a list of employees of the employer can be provided to the user, and the user can select an employee from the list in order to attribute the review to the employee. In this manner, the disclosed technology can provide a framework for attributing reviews to specific employees of an employer. Additional details relating to the disclosed technology are provided below.

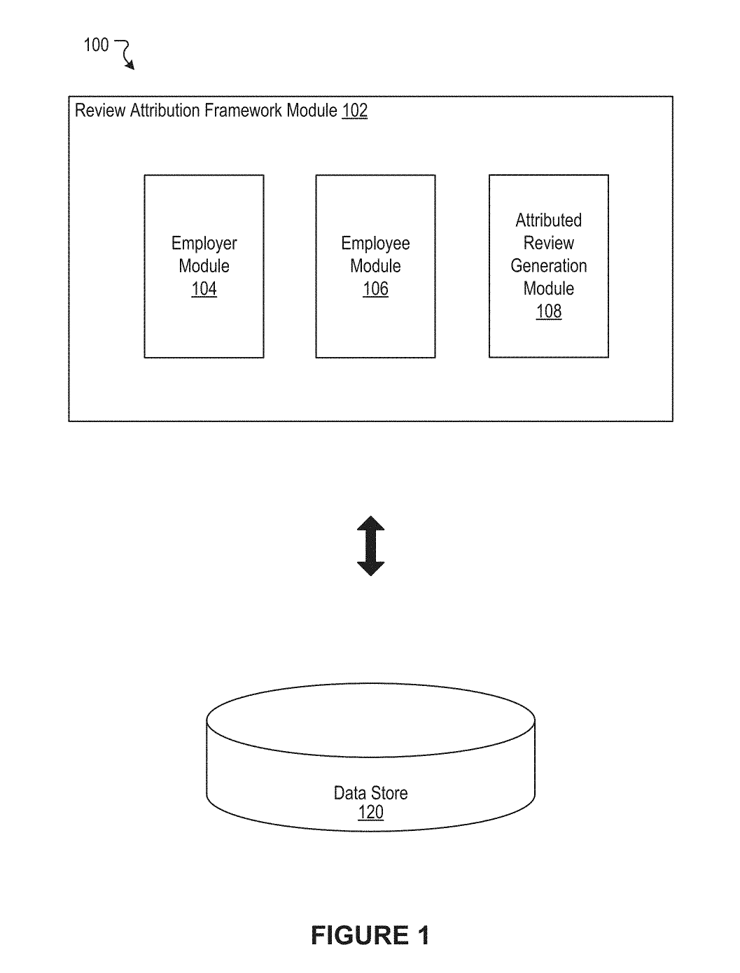

FIG. 1 illustrates an example system 100 including an example review attribution framework module 102 configured to provide attributed reviews associated with entities, according to an embodiment of the present disclosure. The review attribution framework module 102 can include an employer module 104, an employee module 106, and an attributed review generation module 108. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the review attribution framework module 102 can be implemented in any suitable combinations. While the disclosed technology is described in connection with reviews associated with entities provided by a social networking system for illustrative purposes, the disclosed technology can apply to any other type of system and/or content.

Various entities can be represented in a social networking system. Examples of entities can include companies, businesses, brands, products, artists, public figures, entertainment, individuals, etc. As referenced, in some embodiments, an entity can be represented as a page in the social networking system. For instance, a page can be a profile or other representation of an entity. A page is one example of a representation of an entity, and an entity can be represented within the social networking system in various ways. An entity can have various associated people that work for or with the entity. Examples of associated people of an entity can include employees, independent contractors, affiliated people, etc. As discussed herein, an entity is referred to as an “employer,” and a person associated with an entity is referred to as an “employee” for illustrative purposes, but entities and associated people can include any type of entity and any person associated with an entity, respectively. As discussed herein, a review relating to an entity that attributes the review to a particular employee of the entity can be referred to as an “attributed review.” Attributed reviews can be provided via various applications and/or surfaces. In some embodiments, attributed reviews can be provided via a page associated with an employer. In other embodiments, attributed reviews may be provided via various applications, such as a photo sharing application, a messaging application, etc. As discussed herein, attributed reviews are described as being provided on a page associated with an employer for illustrative purposes, but attributed reviews can be provided via any application and/or surface as appropriate.

The employer module 104 can allow employers to manage attributed reviews based on their roles as employers. For example, the employer module 104 can allow an employer to opt in to review attribution, manage a list of employees, and manage reviews relating to employees. The employer module 104 is described in more detail herein.

The employee module 106 can allow employees to manage attributed reviews based on their roles as employees. For example, the employee module 106 can allow an employee to opt in to review attribution, generate a profile of an employee, specify sharing settings for reviews relating to an employee, and otherwise manage reviews relating to an employee. The employee module 106 is described in more detail herein.

The attributed review generation module 108 can generate attributed reviews. For example, the attributed review generation module 108 can allow a user to create an attributed review and specify sharing settings for reviews created by the user. The attributed review generation module 108 is described in more detail herein.

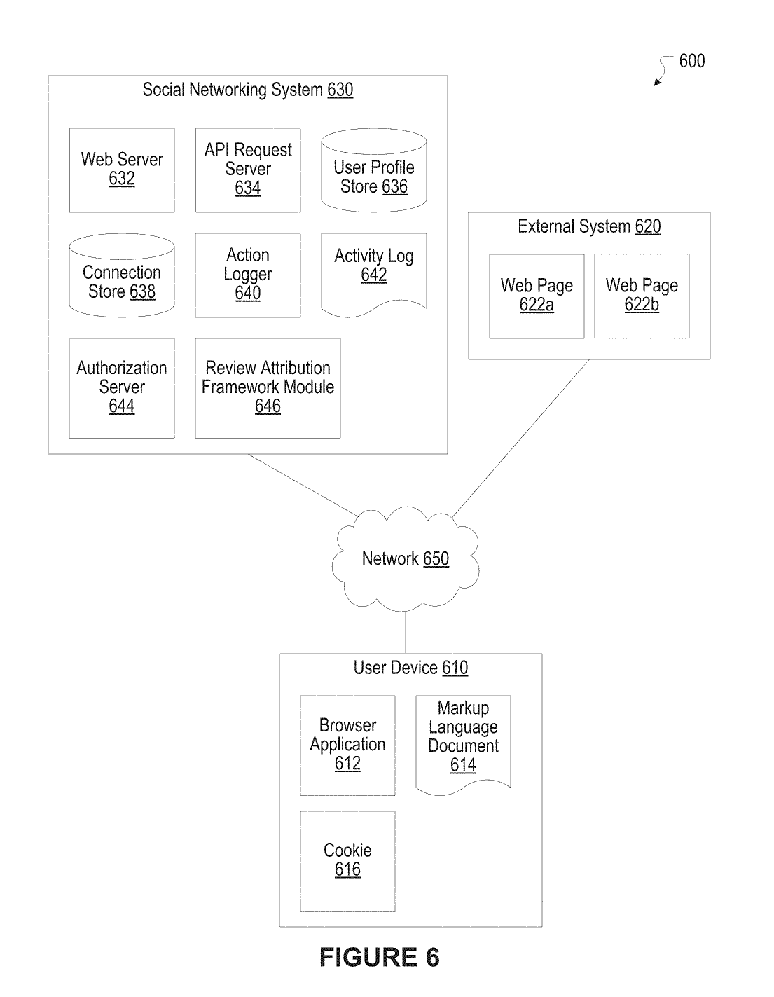

In some embodiments, the review attribution framework module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the review attribution framework module 102 can be, in part or in whole, implemented as software running on one or more computing devices or systems, such as on a server system or a client computing device. In some instances, the review attribution framework module 102 can be, in part or in whole, implemented within or configured to operate in conjunction or be integrated with a social networking system (or service), such as a social networking system 630 of FIG. 6. Likewise, in some instances, the review attribution framework module 102 can be, in part or in whole, implemented within or configured to operate in conjunction or be integrated with a client computing device, such as the user device 610 of FIG. 6. For example, the review attribution framework module 102 can be implemented as or within a dedicated application (e.g., app), a program, or an applet running on a user computing device or client computing system. The application incorporating or implementing instructions for performing functionality of the review attribution framework module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The data store 120 can be configured to store and maintain various types of data, such as the data relating to support of and operation of the review attribution framework module 102. The data maintained by the data store 120 can include, for example, information relating to reviews, including attributed reviews, attributions, pages, entities, people associated with entities, profiles of people associated with entities, employers, employees, employee profiles, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the review attribution framework module 102 can be configured to communicate and/or operate with the data store 120. In some embodiments, the data store 120 can be a data store within a client computing device. In some embodiments, the data store 120 can be a data store of a server system in communication with the client computing device.

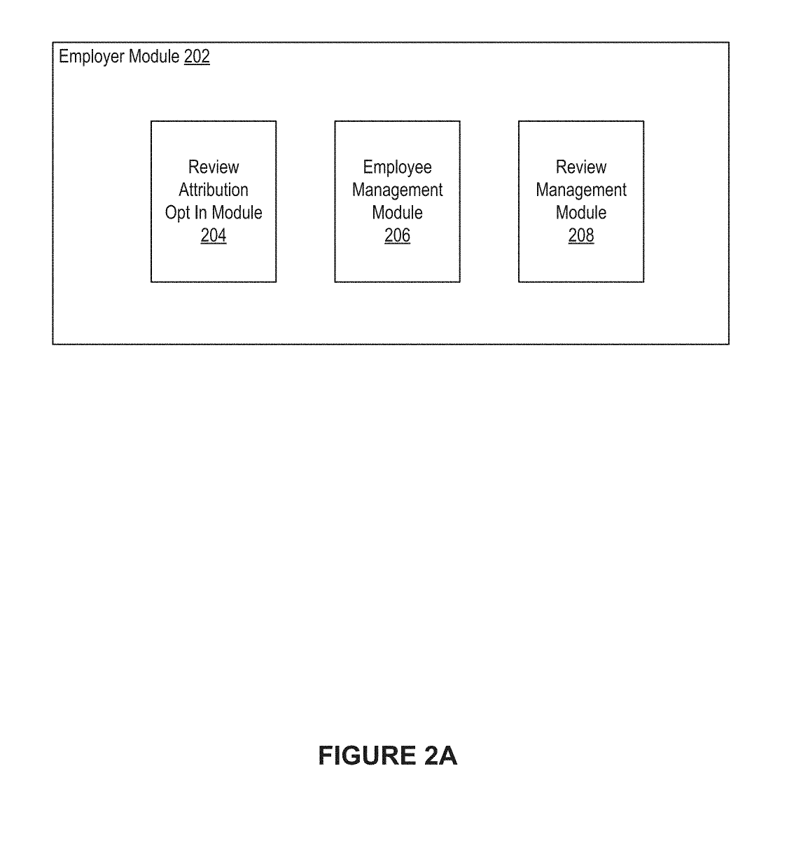

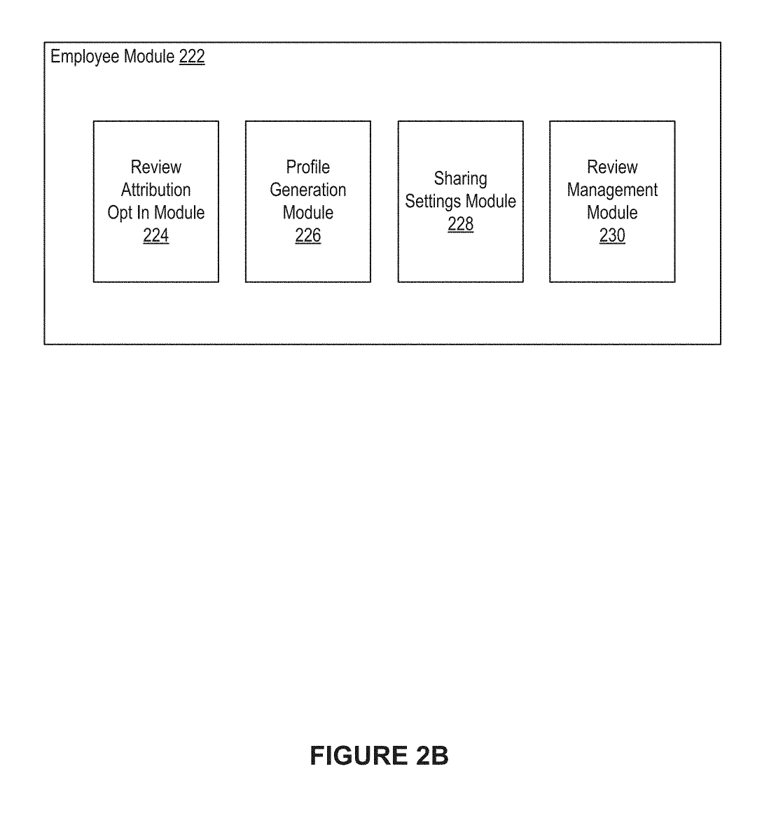

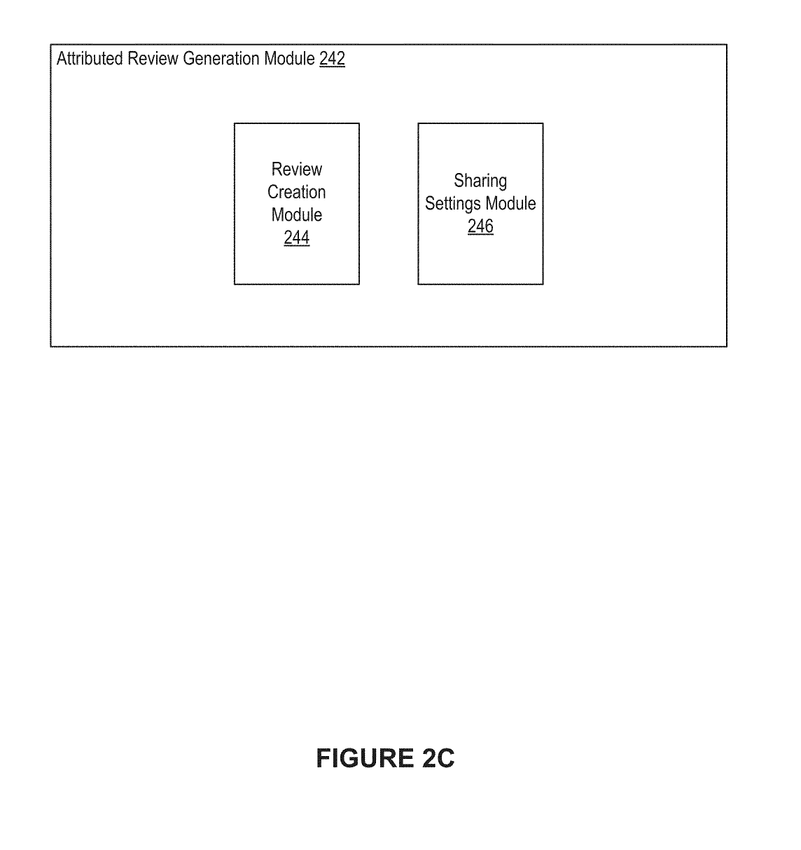

FIG. 2A illustrates an example employer module 202 configured to allow employer management of attributed reviews, according to an embodiment of the present disclosure. In some embodiments, the employer module 104 of FIG. 1 can be implemented with the example employer module 202. As shown in the example of FIG. 2A, the example employer module 202 can include a review attribution opt in module 204, an employee management module 206, and a review management module 208.

The review attribution opt in module 204 can provide settings for an employer to enable attributed reviews. If an employer chooses to enable attributed reviews, a list of employees of the employer can be provided in connection with user reviews for the employer, and the user reviews for the employer can be attributed to one or more employees of the employer. The review attribution opt in module 204 can provide one or more user interface (UI) elements as controllable settings for enabling attributed reviews. The UI elements can be presented in a user interface provided through an application running on a client computing device associated with an employer. Examples of UI elements can include a checkbox, a button, a toggle, etc. Many variations are possible. In some embodiments, the settings for enabling attributed reviews can be provided via an administrator view of a page associated with the employer.

The employee management module 206 can allow an employer to create and maintain a list of employees of an employer. The employee management module 206 can allow the employer to add employees to the list and/or remove employees from the list. For example, employees in the list can be people who are verified by the employer as employees of the employer. The list of employees can include employees that have opted in to enabling attributed reviews. An employee can opt in to enable attributed reviews relating to the employee, as described below. Each employee in the list that has opted in to attributed reviews can have a profile that can be provided in connection with attributed reviews. In some embodiments, controllable settings to allow management of a list of employees of an employer can be provided via an administrator view of a page associated with the employer.

The review management module 208 can allow an employer to manage attributed reviews. Users visiting a page associated with an employer can create reviews relating to the employer, such as an attributed review. In some instances, the attributed review may include an action item, a question, incorrect information that needs to be addressed, etc. The review management module 208 can allow the employer to respond to or follow up with an attributed review. In some instances, status or other relevant information can be displayed for attributed reviews. The review management module 208 may provide tools to search through attributed reviews, sort attributed reviews, etc. based on the status or other relevant information. In certain embodiments, the review management module 208 can allow management of all reviews, regardless of whether the reviews are attributed reviews or not. In some embodiments, controllable settings to allow management of attributed reviews can be provided via an administrator view of a page associated with the employer. All examples herein are provided for illustrative purposes, and there can be many variations and other possibilities.

FIG. 2B illustrates an example employee module 222 configured to allow employee management of attributed reviews, according to an embodiment of the present disclosure. In some embodiments, the employee module 106 of FIG. 1 can be implemented with the example employee module 222. As shown in the example of FIG. 2B, the example employee module 222 can include a review attribution opt in module 224, a profile generation module 226, a sharing settings module 228, and a review management module 230.

The review attribution opt in module 224 can provide settings for an employee to enable attributed reviews. An employee can opt in to enable user reviews for an employer to be attributed to the employee. In some instances, an employee may work for multiple employers, and the review attribution opt in module 224 can allow the employee to separately enable attributed reviews for each employer. If an employee chooses to enable attributed reviews, the employee can appear in a list of employees of the employer that can be provided in connection with user reviews for the employer, and the user reviews for the employer can be attributed to the employee. The review attribution opt in module 224 can provide one or more UI elements as controllable settings for enabling attributed reviews. The UI elements can be presented in a user interface provided through an application running on a client computing device associated with an employer. Examples of UI elements can include a checkbox, a button, a toggle, etc. Many variations are possible. In some embodiments, the settings for an employee to enable attributed reviews for a particular employer can be provided via a page associated with the employer. In other embodiments, the settings for an employee to enable attributed reviews for employers can be provided via another user interface, such as a profile associated with the employee.

The profile generation module 226 can allow an employee to generate an employee profile. An employee can create an employee profile for a particular employer. The employee can customize information included in the employee profile. Examples of information included in an employee profile can include the name of the employee, a profile photo, a role of the employee, etc. The employee profile for an employer can be separate from a personal profile of the employee. In some embodiments, at least some information from the personal profile of the employee can be provided as default information for the employee profile of the employee. For example, the name of the employee and the profile photo from the personal profile of the employee can be provided as a default name in the employee and a default profile photo of the employee profile of the employee. If the employee works for multiple employers, the employee can create a separate employee profile for each employer or at least one of the multiple employers. In some embodiments, an employee can generate an employee profile for a particular employer via a page associated with the employer.

The sharing settings module 228 can allow an employee to specify sharing options for attributed reviews about the employee. Attributed reviews relating to an employer can be provided, for example, on a page associated with the employer. The employee can also choose to share attributed reviews for the employee with other users, such as connections of the employee. The employee can indicate whether to share an attributed review and/or an audience with which to share an attributed review. For example, the employee can indicate not to share an attributed review with anyone, and the attributed review can only be provided on a page associated with a corresponding employer. As another example, the employee can share an attributed review with connections of the employee. For instance, connections of the employee can be indicated as the audience for the attributed review. As a further example, the employee can share an attributed review publicly. For instance, all users of a social networking system can be indicated as the audience for the attributed review. If the employee indicates to share an attributed review, the attributed review may be provided in a feed (e.g., a news feed) of a specified audience. The attributed review can also be added to the personal profile of the employee for access by a specified audience. The sharing settings module 228 can allow the employee to specify a sharing option for each attributed review. The sharing settings module 228 can also allow the employee to specify a sharing option that applies to all attributed reviews.

The review management module 230 can allow management of attributed reviews relating to an employee. An employee may be associated with multiple employers simultaneously or over time and accordingly may have attributed reviews in connection with the multiple employers. The review management module 230 can aggregate and maintain such attributed reviews. For example, the attributed reviews relating to the employee can serve as a reference for the employee if the employee chooses to share the attributed reviews. In some embodiments, a social networking system or other online resource may allow employers to post job positions, and users can search through and apply for the job positions. When a user applies for a job position, the user can choose to make some or all attributed reviews relating to the user available to a potential employer, and the attributed reviews can serve as references or information supporting candidacy of the user for the position. The review management module 230 can provide controllable settings for managing attributed reviews relating to an employee via a user interface, such as a personal profile or an employee profile of the employee supported by an application running on client computing device. All examples herein are provided for illustrative purposes, and there can be many variations and other possibilities.

FIG. 2C illustrates an example attributed review generation module 242 configured to generate attributed reviews, according to an embodiment of the present disclosure. In some embodiments, the attributed review generation module 108 of FIG. 1 can be implemented with the example attributed review generation module 242. As shown in the example of FIG. 2C, the example attributed review generation module 242 can include a review creation module 244 and a sharing settings module 246.

The review creation module 244 can allow creation of an attributed review for an employer. The review creation module 244 can receive text or other information for a review provided by a user. For example, a text input element for creating a review can be provided in a user interface of an application running on a computing device of the user. If a portion of the text for a review matches a name of an employee of the employer who has opted in to attributed reviews or a portion of the name, the review creation module 244 can provide a list of potential matching employees to the computing device of the user. As an example, a UI element showing a list of potential matching employees can be displayed. The list of potential matching employees can include for each employee in the list the name of the employee, a profile photo of the employee, a role of the employee, etc. The user can select an employee from the list of potential matching employees in order to attribute the review to the employee. If the review is attributed to a particular employee, the review creation module 244 can generate a link to the employee profile of the employee for the employer. The review creation module 244 can add the link to the review. The employee profile of the employee or a summary of the employee profile may be displayed in response to selection of or hovering over the link by the user. The employee profile or the summary can be displayed in this manner during review creation and after the review is published. The employee profile or the summary of the employee profile displayed to the user can include the name of the employee, the profile photo of the employee, a cover photo, the role of the employee, contact information, etc. In some embodiments, a review can be attributed to multiple employees of an employer. A user can enter names of multiple employees of the employer when creating a review. For example, the user may select an appropriate employee from a list of potential matching employees for each of the multiple employees. The review creation module 244 can generate a link to the employee profile of each of the multiple employees and add the links to the review.

Once a user creates an attributed review for an employee of an employer, the review creation module 244 can publish the attributed review on a page associated with the employer. The review creation module 244 can send a notification to the employee that an attributed review has been created for the employee. The user may edit the attributed review. In some embodiments, however, the attributed review may not be edited by the employer or the employee. If there are any actions items associated with the attributed review, the employer can communicate with the user and take an action in connection with the review. In some embodiments, the employee may also be able to communicate with the user and take an action in connection with the review.

The sharing settings module 246 can allow a user to specify sharing options for attributed reviews created by the user. Attributed reviews created by the user can be provided in connection with an employer, for example, on a page associated with the employer. The user can also choose to share attributed reviews the user creates with other users, such as connections of the user. The user can indicate whether to share an attributed review and/or an audience with which to share an attributed review. For example, the user can indicate not to share an attributed review with anyone, and the attributed review can only be provided on a page associated with a corresponding employer. As another example, the user can share an attributed review with connections of the user. For instance, connections of the user can be indicated as the audience for the attributed review. As a further example, the user can share an attributed review publicly. For instance, all users of a social networking system can be indicated as the audience for the attributed review. If the user indicates to share an attributed review, the attributed review may be provided in a feed (e.g., a news feed) of a specified audience. The attributed review can also be added to the personal profile of the user for access by a specified audience. The sharing settings module 246 can allow the user to specify a sharing option for each attributed review created by the user or allow the user to specify a sharing option for all attributed reviews created by the user.

In this way, the disclosed technology can provide a framework for attributed reviews. Based on the review attribution framework module 102, a review can be clearly attributed to a particular employee of an employer, which can provide an incentive for increased performance for employees. The review attribution framework module 102 can also facilitate quantitative evaluation of an employee based on reviews attributable to the employee. In some embodiments, an employer can determine scores indicative of loyalty between an employer and a user based on user perception of employees in attributed reviews. As an example, a net promoter score (NPS) indicative of loyalty between a provider and a consumer can be determined based on attributed reviews. The review attribution framework module 102 can also provide exposure to work of an employee and an employer, for example, through sharing of attributed reviews with other users, such as connections of an employee. The review attribution framework module 102 may provide references and a measure of past work quality of an employee, for example, in a job search and job application process through a social networking system or other online resource. The review attribution framework module 102 can further provide helpful information relating to employees to other users who are reading attributed reviews. All examples herein are provided for illustrative purposes, and there can be many variations and other possibilities.

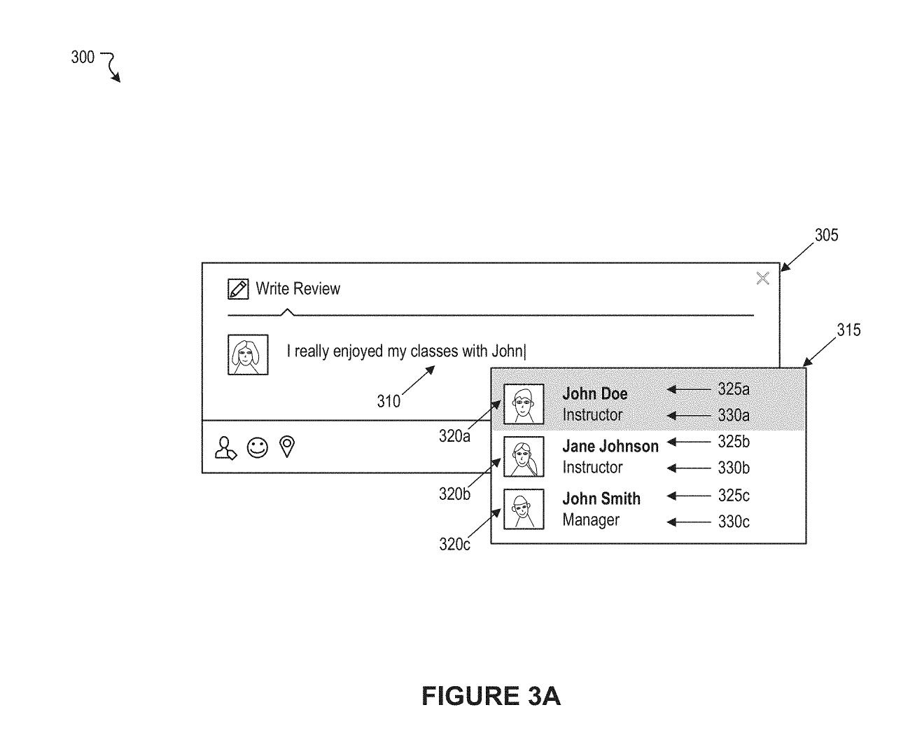

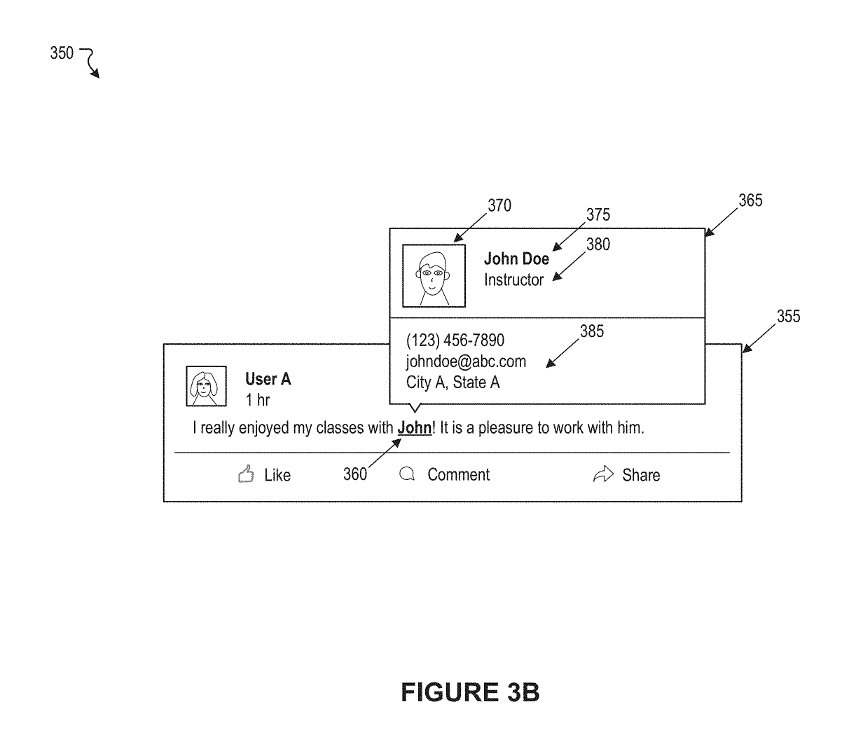

FIG. 3A illustrates an example scenario 300 for providing attributed reviews associated with entities, according to an embodiment of the present disclosure. For example, attributed reviews can be generated and provided by the review attribution framework module 102, as described herein. In the example scenario 300, a user can create a review associated with an employer. For example, the user creating the review may enter text 310 for the review in a text input element 305. In the example scenario 300, the text 310 is shown as “I really enjoyed my classes with John . . . .” The text 310 can be checked in order to determine whether a portion of the text 310 matches at least a portion of a name of an employee associated with the employer. For instance, the text 310 can be checked periodically, at a predetermined frequency, in or near real time, etc. If the name of an employee matches a portion of the text 310 at least in part, the name of the employee can be provided in a list 315. In the example scenario 300, the user enters the name “John” as a part of the text 310, and the list 315 including employees “John Doe,” “Jane Johnson,” and “John Smith” is provided to the user. The list 315 can include a profile photo 320a-c, a name 325a-c, and a role 330a-c for each employee in the list 315. In this example, the user selects “John Doe” as an employee to whom the review should be attributed. In some embodiments, the user can enter names of multiple employees of the employer in order to attribute the review to multiple employees.

FIG. 3B illustrates an example scenario 350 for providing attributed reviews associated with entities, according to an embodiment of the present disclosure. The example scenario 350 shows a review 355 that is provided in connection with an employer via an application and/or a surface. For example, the review 355 can be published on a page associated with an employer. In this example, the review 355 is the review created by the user in the example of FIG. 3A. The review 355 includes a link 360 to an employee profile or a summary of an employee. In response to selection of the link 360 or hovering over the link 360 by a user, an employee profile or a summary 365 of the employee can be provided. In some embodiments, a profile page of the employee may be displayed in response to selection of the link 360. For instance, the profile page can display the employee profile. The employee profile or the summary 365 can include a profile photo 370 of the employee, the name 375 of the employee, a role 380 of the employee in connection with the employer, and other information 385 associated with the employee. The other information 385 associated with the employee can include contact information, such as a phone number, an email address, a location, etc. Many variations are possible. For example, the employee profile or the summary 365 can be presented in the review 355 without a need to select or hover over a link. All examples herein are provided for illustrative purposes, and there can be many variations and other possibilities.

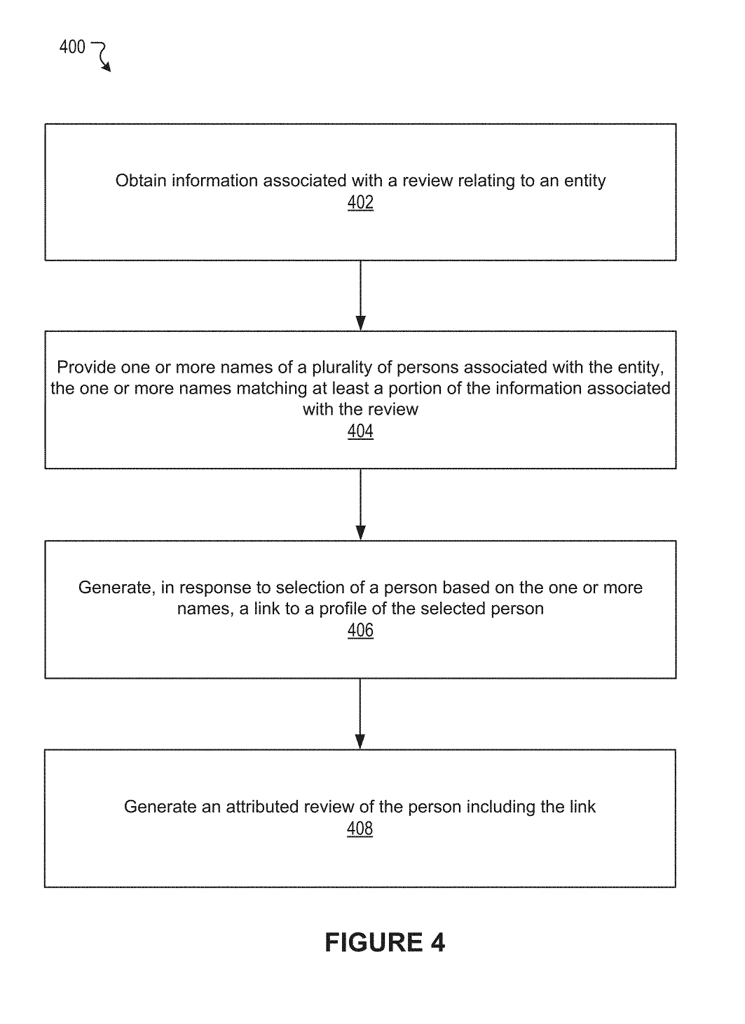

FIG. 4 illustrates an example first method 400 for providing attributed reviews associated with entities, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain information associated with a review relating to an entity. At block 404, the example method 400 can provide one or more names of a plurality of persons associated with the entity, the one or more names matching at least a portion of the information associated with the review. At block 406, the example method 400 can generate, in response to selection of a person based on the one or more names, a link to a profile of the selected person. At block 408, the example method 400 can generate an attributed review of the person including the link. Other suitable techniques that incorporate various features and embodiments of the present disclosure are possible.

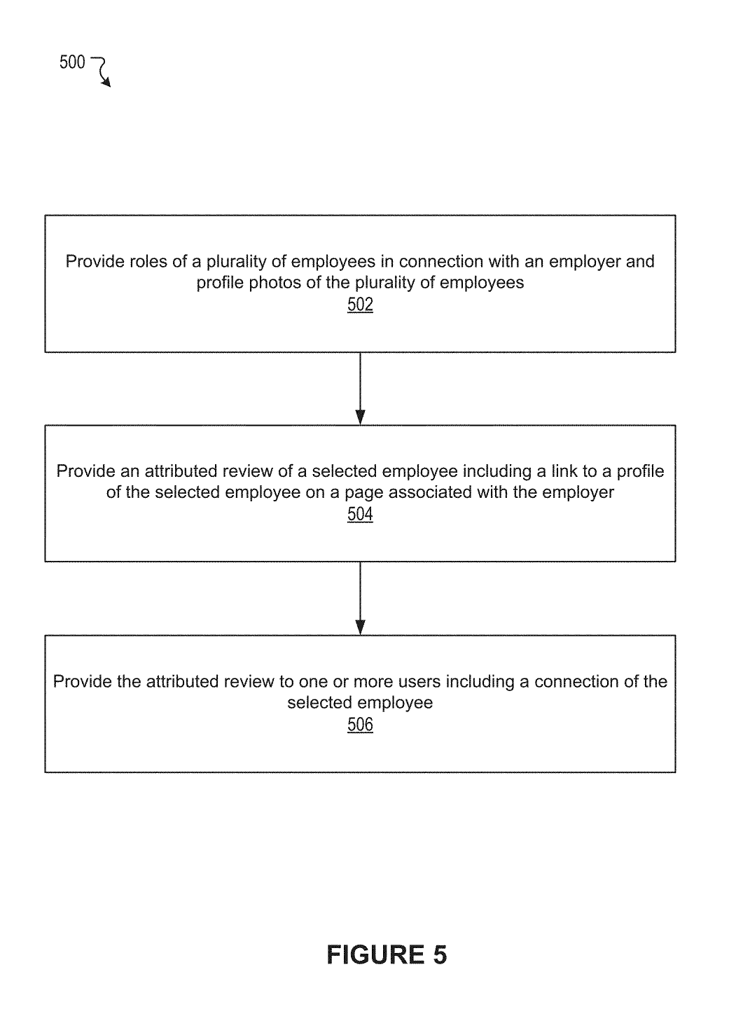

FIG. 5 illustrates an example second method 500 for providing attributed reviews associated with entities, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can provide roles of a plurality of employees in connection with an employer and profile photos of the plurality of employees. At block 504, the example method 500 can provide an attributed review of a selected employee including a link to a profile of the selected employee on a page associated with the employer. At block 506, the example method 500 can provide the attributed review to one or more users including a connection of the selected employee. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a review attribution framework module 646. The review attribution framework module 646 can be implemented with the review attribution framework module 102, as discussed in more detail herein. In some embodiments, one or more functionalities of the review attribution framework module 646 can be implemented in the user device 610.

### HARDWARE IMPLEMENTATION

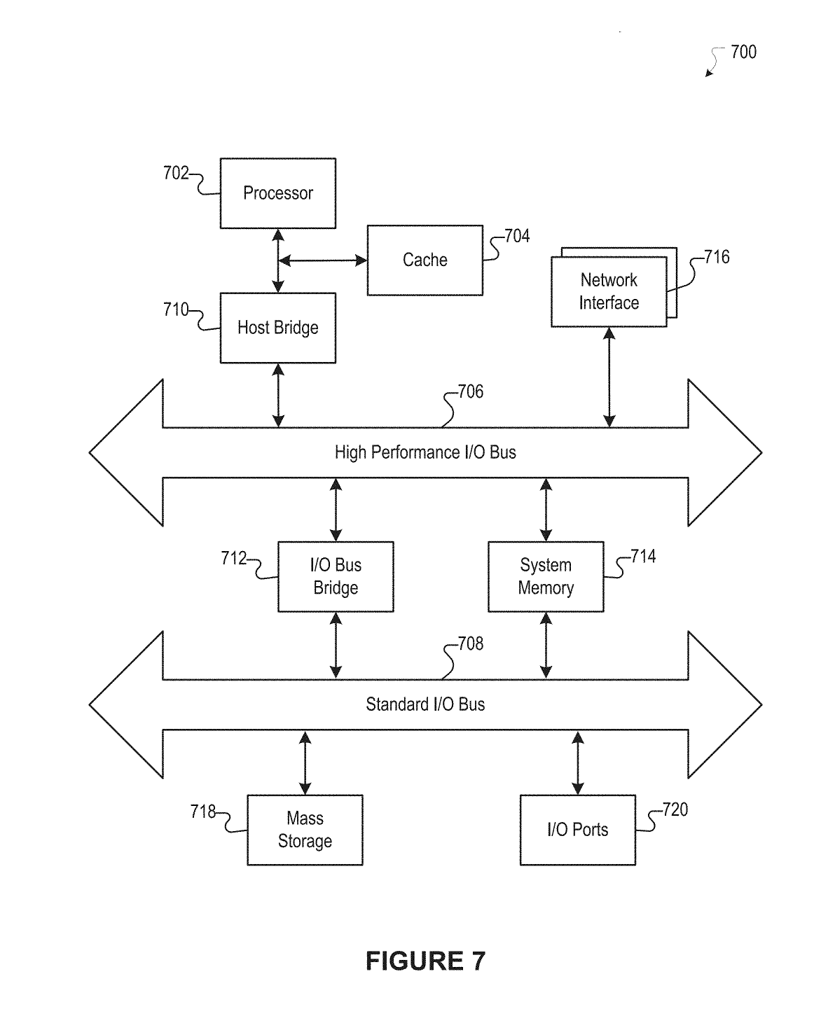

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, information associated with a review relating to an entity;
providing, by the computing system, one or more names of a plurality of persons associated with the entity, the one or more names matching at least a portion of the information associated with the review;
generating, by the computing system, in response to selection of a person based on the one or more names, a link to a profile of the selected person; and
generating, by the computing system, an attributed review of the person including the link.

2. The computer-implemented method of claim 1, wherein the profile includes one or more of: a name of the selected person, a profile photo of the selected person, a cover photo associated with the selected person, or a role of the selected person in connection with the entity.

3. The computer-implemented method of claim 1, wherein the entity is an employer, the plurality of persons is a plurality of employees, and the selected person is a selected employee.

4. The computer-implemented method of claim 3, wherein the employer has enabled an opt in for allowing a user creating a review relating to the employer to attribute the review to at least one of the plurality of employees associated with the employer.

5. The computer-implemented method of claim 3, wherein the selected employee has enabled an opt in for attributing a review relating to the employer to the selected employee.

6. The computer-implemented method of claim 3, wherein the providing one or more names of a plurality of persons includes providing roles of the plurality of employees in connection with the employer and profile photos of the plurality of employees.

7. The computer-implemented method of claim 3, wherein the employer is represented as a page within a social networking system, and the attributed review is published on the page.

8. The computer-implemented method of claim 3, wherein the attributed review is shared with one or more users including a connection of the selected employee.

9. The computer-implemented method of claim 3, further comprising aggregating attributed reviews relating to the selected employee, wherein the attributed reviews relate to a plurality of employers including the employer.

10. The computer-implemented method of claim 3, wherein the selected employee is associated with a plurality of employers and a respective profile is created for each employer of the plurality of employers.

11. A system comprising:
at least one hardware processor; and
a memory storing instructions that, when executed by the at least one processor, cause the system to perform:
obtaining information associated with a review relating to an entity;
providing one or more names of a plurality of persons associated with the entity, the one or more names matching at least a portion of the information associated with the review;
generating, in response to selection of a person based on the one or more names, a link to a profile of the selected person; and
generating an attributed review of the person including the link.

12. The system of claim 11, wherein the profile includes one or more of: a name of the selected person, a profile photo of the selected person, a cover photo associated with the selected person, or a role of the selected person in connection with the entity.

13. The system of claim 11, wherein the entity is an employer, the plurality of persons is a plurality of employees, and the selected person is a selected employee.

14. The system of claim 12, wherein the providing one or more names of a plurality of persons includes providing roles of the plurality of employees in connection with the employer and profile photos of the plurality of employees.

15. The system of claim 12, wherein the attributed review is shared with one or more users including a connection of the selected employee.

16. A non-transitory computer readable medium including instructions that, when executed by at least one hardware processor of a computing system, cause the computing system to perform a method comprising:
obtaining information associated with a review relating to an entity;
providing one or more names of a plurality of persons associated with the entity, the one or more names matching at least a portion of the information associated with the review;
generating, in response to selection of a person based on the one or more names, a link to a profile of the selected person; and
generating an attributed review of the person including the link.

17. The non-transitory computer readable medium of claim 16, wherein the profile includes one or more of: a name of the selected person, a profile photo of the selected person, a cover photo associated with the selected person, or a role of the selected person in connection with the entity.

18. The non-transitory computer readable medium of claim 16, wherein the entity is an employer, the plurality of persons is a plurality of employees, and the selected person is a selected employee.

19. The non-transitory computer readable medium of claim 18, wherein the providing one or more names of a plurality of persons includes providing roles of the plurality of employees in connection with the employer and profile photos of the plurality of employees.

20. The non-transitory computer readable medium of claim 18, wherein the attributed review is shared with one or more users including a connection of the selected employee.
